(19) United States
(12) Patent Application Publication
(10) Pub. No.: US 2014/0204811 A1
(43) Pub. Date: Jul. 24, 2014

(54) METHOD FOR FEEDING BACK DIFFERENT UPLINK-DOWNLINK CONFIGURATION RATIOS FOR LTE-A TDD

(71) Applicants: Zhi Lu, Beijing (CN); Zhe Chen, Beijing (CN); Liangang Chi, Beijing (CN); Lianhai Wu, Beijing (CN)

(72) Inventors: Zhi Lu, Beijing (CN); Zhe Chen, Beijing (CN); Liangang Chi, Beijing (CN); Lianhai Wu, Beijing (CN)

(73) Assignee: POTEVIO INSTITUTE OF TECHNOLOGY CO., LTD., Beijing (CN)

(21) Appl. No.: 14/238,805

(22) PCT Filed: Aug. 10, 2012
(86) PCT No.: PCT/CN2012/079952

§ 371 Date: Feb. 13, 2014

(30) Foreign Application Priority Data
Aug. 15, 2011 (CN) 201110232744.2

(51) Int. Cl. H04L 5/00; H04L 5/14

(52) U.S. Cl. CPC H04L 5/0055; H04L 5/14
USPC 370/280

(57) ABSTRACT

Provided is a method for feeding back different uplink-downlink configuration ratios for LTE-A TDD. For an asymmetric uplink and downlink sub-frame in a carrier aggregation scenario, the uplink sub-frame of each component carrier only feeds back Ack/Nack of the downlink sub-frame PDSCH of the current carrier, not feeding back Ack/Nack of other carriers. Also proposed is another method for feeding back different uplink-downlink configuration ratios for LTE-A TDD. For an asymmetric uplink and downlink sub-frame in a carrier aggregation scenario, Ack/Nack of the downlink sub-frame of each component carrier is fed back by the uplink sub-frame of the closest auxiliary cell with the minimum auxiliary cell index value after at least four sub-frames, allowing Ack/Nack of a plurality of carriers to be transmitted on other carriers. The present invention takes advantage of the asymmetry characteristic of uplink sub-frames of different sub-frame configuration ratios, which can reduce the maximum value of Ack/Nack of the downlink sub-frame PDSCH fed back in the uplink sub-frame, decreasing the time delay in feeding back Ack/Nack of the downlink sub-frame to the eNB.

The present application claims the priority to Chinese Patent Application No. 201110232744.2, entitled “METHOD FOR FEEDING BACK DIFFERENT UPLINK-DOWNLINK CONFIGURATION RATIOS FOR LTE-A TDD”, filed on Aug. 15, 2011 with the Chinese State Intellectual Property Office, which is incorporated herein by reference in its entirety.

### FIELD

The present disclosure relates to the wireless communication technique and in particular to a feedback method for different uplink-downlink configurations for LTE-A time division duplex (TDD).

### BACKGROUND

For LTE-A Release10 (Rel-10), a concept of carrier aggregation is introduced to support wider bandwidth, i.e., two or more carriers are aggregated to support transmission bandwidth of LTE-A more than 20 MHz. Only an intra-band scenario is supported for the time division duplex (TDD) of the carrier aggregation of Rel-10, where the band refers to available radio spectrum resource defined by International Telecommunication Union. In this case, if the uplink-downlink configurations are different, a severe interference may occur between the uplink and downlink in the process of receiving and transmitting; hence the aggregated carriers are required to adopt the same TDD uplink-downlink configuration. FIG. 1 illustrates that the same uplink-downlink configuration is adopted in a carrier aggregation scenario of Rel-10. In FIG. 1, CC1 to CC5 represent carriers participated in the carrier aggregation, D represents a downlink subframe of a carrier, U represents an uplink subframe of a carrier, and S represents a special subframe (the carriers may be configured with different special subframes). Table 1 shows uplink to downlink configurations.

TABLE 1

| uplink-downlink | duration for switching from | subframe number | | | | | | | | | |
|---|---|---|---|---|---|---|---|---|---|---|---|
| configuration | downlink to uplink | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Seven uplink-downlink configurations from configuration 0 to configuration 6 are listed in Table 1. In configuration 0, subframes 0 and 5 are downlink subframes, and subframes 2, 3, 4, 7, 8, 9 are uplink subframes, so the uplink to downlink ratio is 3:1 (the two special subframes are not included). The uplink-downlink configurations of other configurations may also be obtained from Table 1.

A concept of inter-band carrier aggregation is introduced in LTE-A Release11, in order to utilize resources more flexibly. In addition, since frequencies in different bands are adopted for the inter-band carrier aggregation, the interference between the uplink and downlink in the process of receiving and transmitting is small. However, in this case, the user equipment (UE) and the base station (eNB) are required to have capabilities of simultaneous transmission and reception. For Rel-11 carrier aggregation, if different uplink-downlink configurations are adopted in different bands, the number of the uplink subframes may not be matched with the number of the downlink subframes, as indicated by ellipses in FIGS. 2a to 2c. FIG. 2a illustrates a case that durations for switching from downlink to uplink of two carriers CC1 and CC2 participated in the carrier aggregation are both 5 ms. FIG. 2b illustrates a case that durations for switching from downlink to uplink of two carriers CC1 and CC2 participated in the carrier aggregation are both 10 ms. FIG. 2c illustrates a case that durations for switching from downlink to uplink of two carriers CC1 and CC2 participated in the carrier aggregation are 5 ms and 10 ms respectively.

For Rel-8/9/10, there are the different uplink-downlink configurations for TDD, so the feedback message (Ack/Nack) of the physical downlink shared channel (PDSCH) can be sent only if there has an uplink subframe (PUCCH or PUSCH). The hybrid automatic repeat request (HARQ) is designed based on the following two principles:

1, UE would transmit Ack/Nack in the first uplink subframe at least four subframes later;

2, Ack/Nack is distributed in time domain based on the principle that the number of Ack/Nacks carried in one uplink subframe should be minimized.

Based on the above two principles, for some heavy load services, one uplink subframe may be used to feed back Ack/Nacks of multiple downlink subframes. Table 2 shows corresponding relations between the downlink and uplink in feeding back the Ack/Nacks.

TABLE 2

| uplink-downlink | subframe n | | | | | | | | | |
|---|---|---|---|---|---|---|---|---|---|---|
| configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

As shown in Table 2, configuration 1 is taken as an example, Ack/Nacks of downlink subframes n-7 and n-6 are fed back in uplink subframes 2 and 7, where n is subframe number (2 and 7 in this example); Ack/Nack of downlink subframe n-4 is fed back in uplink subframes 3 and 8, where n is subframe number (3 and 8 in this example), as shown in FIG. 3(a). In configuration 4, Ack/Nacks of four downlink subframes are fed back in uplink subframes 2 and 3, as shown in FIG. 3(b). In configuration 5, Ack/Nacks of nine downlink subframes (n-13, n-12, n-9, n-8, n-7, n-5, n-4, n-11 and n-6) are fed back in uplink subframe 2. In this case, the time delay for the Ack/Nack feedback of the downlink subframe to reach the base station is prolonged, hence the processing time of the whole link is increased, and the requirement on the capacity of physical uplink control channel (PUCCH) is higher.

For Rel-10, if the carrier aggregation is adopted, the PUCCH transmission is permitted only on a primary component carrier (PCC), but not permitted on a secondary component carrier (SCC). If there is no PUCCH, only PUSCH of the carrier with a minimum secondary cell index (SCellIndex) value is permitted to carry uplink control information (UCI). If the uplink to downlink ratio is 4:1, 5 component carriers (CCs) are used to feed back Ack/Nack information of 40 bits at most, but PUCCH format 1b and PUCCH format 3 with channel selecting function support respectively Ack/Nacks of 4 bits and 20 bits at most as defined in Rel-10, therefore, in the TDD scenario, spatial bundling may need to be performed on codewords and time bundling may need to be performed on subframes, which affect throughput performance of the TDD system and complicate the design of the TDD system.

### SUMMARY

A method for Ack/Nack feedback in different uplink-downlink configurations for LTE-A TDD is provided by the disclosure. With the asymmetrical uplink subframes in different subframe ratios, the maximum value of Ack/Nacks of the downlink PDSCH fed back in an uplink subframe may be reduced, and the time delay in feeding back Ack/Nack of the downlink subframe to an eNB may be reduced.

A feedback method for different uplink-downlink configurations for LTE-A TDD is provided according to an embodiment of the disclosure. Different bands in time division duplex (TDD) are configured with different uplink-downlink configurations, where for asymmetric uplink and downlink subframes in a carrier aggregation scenario, an uplink subframe of each component carrier is used to feed back a Ack/Nack message of a physical downlink shared channel (PDSCH) of a downlink subframe of the component carrier itself, but is not used to feed back the Ack/Nack message of other carrier.

Preferably, when uplink subframes appear in all the component carriers simultaneously, it is determined whether a physical uplink control channel (PUCCH) is carried on a primary component carrier (PCC), and if it is, the Ack/Nack message is fed back by the physical uplink control channel (PUCCH) carried on the primary component carrier (PCC).

Preferably, if the physical uplink control channel (PUCCH) is not carried on the primary component carrier (PCC), a physical uplink shared channel (PUSCH) of a secondary component carrier (SCC) with a minimum secondary cell index value is selected to feed back the Ack/Nack message.

Preferably, for the asymmetric uplink and downlink subframes in the carrier aggregation scenario, a secondary component carrier (SCC) is permitted to carry a physical uplink control channel (PUCCH) if only one physical uplink control channel (PUCCH) is transmitted in a corresponding subframe; if for a subframe there are multiple uplink subframes and one or more downlink subframes which are asymmetric, the secondary component carrier (SCC) with a minimum secondary cell index value is selected to transmit the physical uplink control channel (PUCCH).

Preferably, all component carriers participated in the carrier aggregation have a same duration for switching from downlink to uplink.

Another feedback method for different uplink-downlink configurations for LTE-A TDD is provided according to an embodiment of the disclosure. Different bands in time division duplex TDD are configured with different uplink-downlink configurations, where for asymmetric uplink and downlink subframes in a carrier aggregation scenario, a Ack/Nack message of a downlink subframe of each component carrier is fed back by an uplink subframe which belongs to a secondary cell (SCC) with a minimum secondary cell index value and which is the first uplink subframe at least four subframes later, and Ack/Nack messages of multiple carriers are permitted to be transmitted on other carrier.

Preferably, when uplink subframes appear in all the component carriers simultaneously, it is determined whether a physical uplink control channel (PUCCH) is carried on a primary component carrier (PCC), and if it is, the Ack/Nack message is fed back by the physical uplink control channel (PUCCH) carried on the primary component carrier (PCC).

Preferably, if the physical uplink control channel (PUCCH) is not carried on the primary component carrier (PCC), a physical uplink shared channel (PUSCH) of a secondary component carrier (SCC) with a minimum secondary cell index value is selected to feed back the Ack/Nack message.

Preferably, for the asymmetric uplink and downlink subframes in the carrier aggregation scenario, a secondary component carrier (SCC) is permitted to carry a physical uplink control channel (PUCCH) if only one physical uplink control channel (PUCCH) is transmitted in a corresponding subframe; if for a subframe there are multiple uplink subframes and one or more downlink subframes which are asymmetric, the secondary component carrier (SCC) with a minimum secondary cell index value is selected to transmit the physical uplink control channel (PUCCH).

Preferably, all component carriers participated in the carrier aggregation have a same duration for switching from downlink to uplink.

From the above technical solutions, in an embodiment of the disclosure, each carrier can maintain its independent HARQ time sequence. Since Ack/Nacks of some downlink subframes are fed back in their respective uplink subframes, the total number of Ack/Nacks fed back may be reduced when the uplink subframes appear in all the component carriers simultaneously, and the Ack/Nack transmission may be distributed due to different subframe ratios. In another embodiment of the disclosure, the time delay in feedback of uplink control information such as Ack/Nack to an eNB may be minimized, and the number of Ack/Nacks carried by each uplink subframe may be more similar. In the solutions of the above embodiments, with the asymmetrical uplink subframes in different subframe ratios, the maximum number of Ack/Nacks of the downlink PDSCH fed back by the uplink subframe may be reduced, and the time delay in feedback of Ack/Nacks of the downlink subframes to an eNB may be reduced.

### BRIEF DESCRIPTION OF THE DRAWINGS

FIG. 1 illustrates that the same uplink-downlink configuration is adopted for all component carriers in a LTE-A Rel-10 carrier aggregation scenario;

FIGS. 2a to 2c illustrate that different uplink-downlink configurations are adopted for all component carriers in a LTE-A Rel-11 carrier aggregation scenario, where FIG. 2a illustrates a case that the durations for switching from downlink to uplink for two carriers participated in the carrier aggregation are both 5 ms, FIG. 2b illustrates a case that the durations for switching from downlink to uplink for two carriers participated in the carrier aggregation are both 10 ms, and FIG. 2c illustrates a case that the durations for switching from downlink to uplink for two carriers participated in the carrier aggregation are 5 ms and 10 ms respectively;

FIGS. 3(a) and 3(b) illustrate respectively timing relations of Ack/Nacks feedback of downlink subframes by uplink subframes in configurations 1 and 4 of uplink and downlink;

FIG. 4 illustrates cases of different uplink-downlink configurations, where Ack/Nack of a carrier is permitted to be fed back in an uplink subframe of other carrier after at least four subframes; and

FIG. 5 illustrates that PUCCH is transmitted by SCC.

### DETAILED DESCRIPTION

The method for Ack/Nack feeback in different uplink-downlink configurations for LTE-A TDD provided by the disclosure includes the following technical features A, B and C.

Feature A: the following two solutions are proposed for the Ack/Nack feedback (timing relation of at least four subframes needs to be met) if different bands in TDD are configured with different uplink-downlink configurations.

The first solution

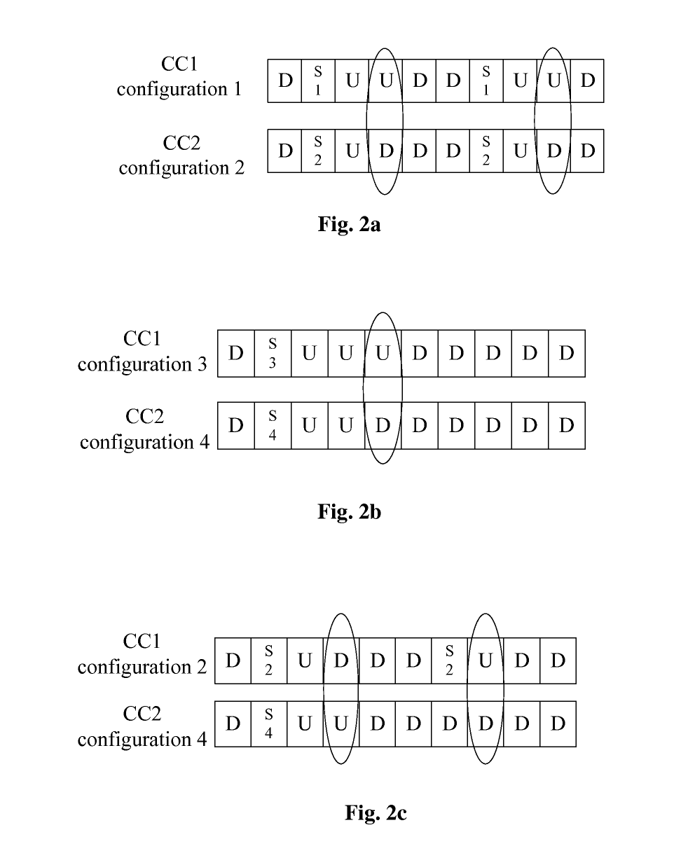

As shown by the ellipses in FIGS. 2(a), 2(b) and 2(c), for asymmetric uplink and downlink subframes in a carrier aggregation scenario, i.e., some carriers are uplink subframes and some carriers are downlink subframes for one subframe, an uplink subframe of each component carrier only feeds back Ack/Nack of a downlink subframe PDSCH of the carrier itself, but does not feed back Ack/Nacks of other carriers. The timing relation of the feedback may refer to the corresponding relation between the downlink subframes and the uplink subframes defined in Table 2.

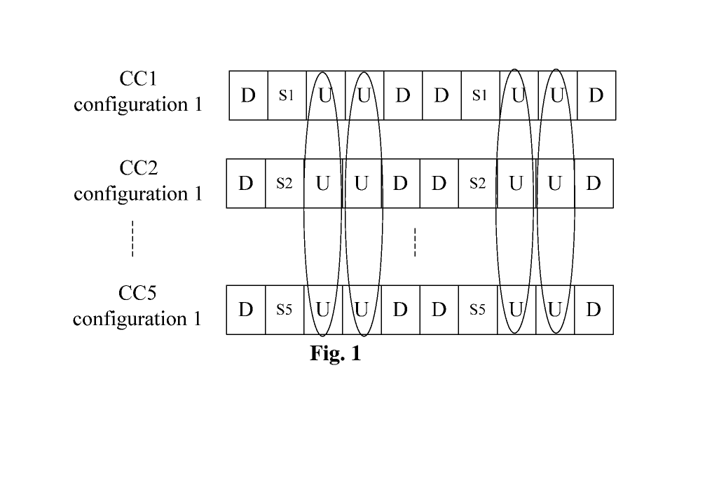

When uplink subframes appear in all the component carriers simultaneously (as shown by the ellipses in FIG. 1), it is determined whether a physical uplink control channel (PUCCH) is carried on a primary component carrier (PCC), and if it is, uplink control information such as Ack/Nack is fed back by PUCCH carried on PCC, but Ack/Nack is not fed back by SCC; otherwise, control information such as Ack/Nack is fed back by PUSCH of SCC with minimum SCellIndex.

The above feedback method is implemented simply and has good backward compatibility, and each carrier maintains its independent HARQ timing relation. Since Ack/Nacks of some downlink subframes are fed back in their respective uplink subframes, the total number of Ack/Nacks fed back may be reduced when uplink subframes appear in all the component carriers simultaneously, and the Ack/Nacks transmission may be distributed due to the different subframe ratios.

The second solution

(1) As shown by the ellipses in FIGS. 2(a), 2(b) and 2(c), for asymmetric uplink and downlink subframes in a carrier aggregation scenario, i.e., some carriers are uplink subframes and some carriers are downlink subframes for one subframe, Ack/Nack of a downlink subframe of each component carrier is fed back by the first uplink subframe at least four subframes later, and Ack/Nack of one carrier is permitted to be transmitted on other carriers, as shown in FIG. 4.

(2) When uplink subframes appear in all the component carriers simultaneously (as shown by the ellipses in FIG. 1), it is determined whether a physical uplink control channel (PUCCH) is carried on a primary component carrier (PCC), and if it is, uplink control information such as Ack/Nack is fed back by PUCCH carried on PCC; otherwise, control information such as Ack/Nack is fed back by PUSCH of SCC with minimum SCellIndex.

In the second solution, the time delay in feeding back the uplink control information such as Ack/Nack to eNB may be minimized, and the number of Ack/Nacks carried by each uplink subframe may be more average.

Feature B: SCC is permitted to carry PUCCH if only one PUCCH is transmitted in a corresponding subframe; if for a subframe there are multiple uplink subframes and one or more downlink subframes which are asymmetric, SCC with minimum SCellIndex is selected to transmit PUCCH.

FIG. 2(a) is taken as an example. If CC2 is configured to be PCC, only CC2 can carry PUCCH. For the uplink subframes of CC1 shown by the ellipses in FIG. 2(a), the control information is transmitted only by PUSCH, in this case an eNB is required to transmit downlink control information (DCI), and additional signaling overhead is required if there is no uplink data being transmitted at this point. Therefore, SCC is permitted to transmit PUCCH, and one PUCCH is still transmitted in a secondary CC even if the uplink and downlink subframes are asymmetric. In this case, the performance of PUCCH is not affected, and it is not required to carry control information overhead by scheduling PUSCH.

Feature C: selection of different configurations for carriers in carrier aggregation.

The first solution: any combination of the uplink and downlink configurations 0-6 in Table 1 is permitted.

The second solution: only combination of configurations with the same duration for switching from downlink to uplink is permitted. That is, only carrier aggregation of the uplink-downlink configuration with duration for switching from downlink to uplink of 5 ms is permitted, or only carrier aggregation of the uplink-downlink configurations with duration for switching from downlink to uplink of 10 ms is permitted, and carrier aggregation of the uplink-downlink configurations with different durations for switching from downlink to uplink of 5 ms and 10 ms respectively is not permitted.

Solutions of the different subframe configurations of other multiple carriers may be considered as the combination of the above three features.

In order to clarify the features and technical effects of the technical solutions of the disclosure, the solutions of the disclosure will be described in detail below by a specific embodiment.

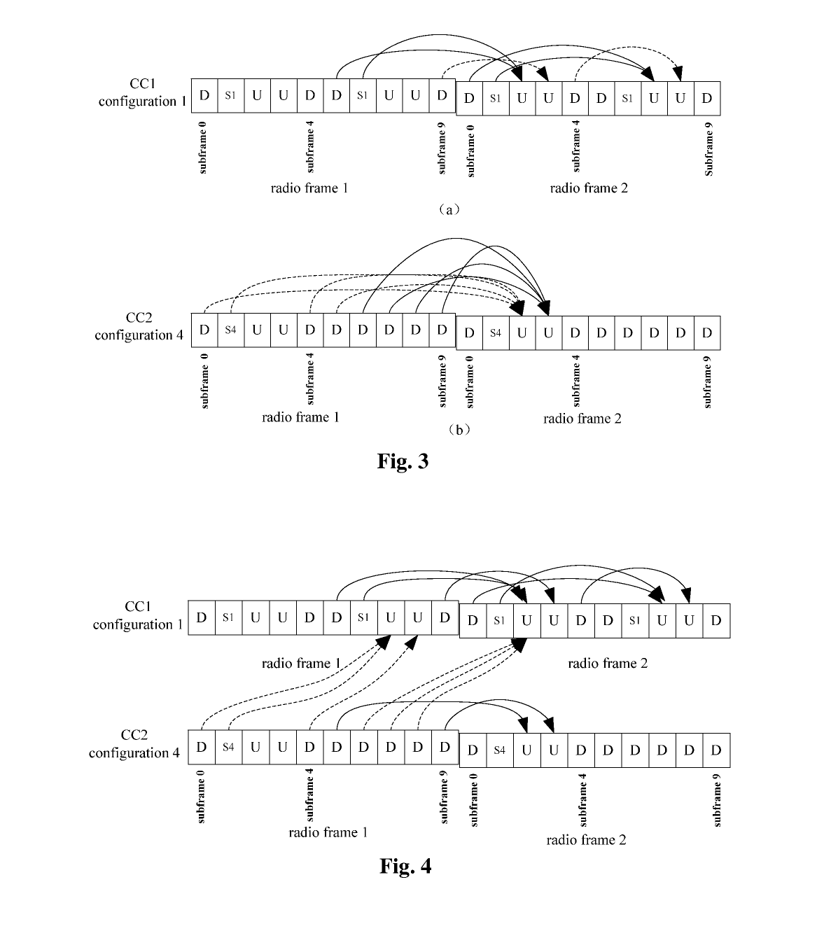

FIG. 3 illustrates the feedback of Ack/Nacks according to the first solution of feature A of the disclosure. Component carriers participated in the carrier aggregation include component carrier 1 (CC1) and component carrier 2 (CC2), where CC1 is configured as configuration 1 in Table 1, and CC2 is configured as configuration 4 in Table 1. Ack/Nack of the downlink subframe of CC1 is fed back in the uplink subframe of CC1, and Ack/Nack of the downlink subframe of CC2 is fed back in the uplink subframe of CC2 (timing relation of the first uplink subframe following at least four subframes needs to be met).

(1) Subframes 7 and 8 of CC1 only feed back Ack/Nack of PDSCH of the downlink subframe of CC1, and do not feed back Ack/Nack of CC2.

(2) For subframes 2 and 3 of radio frames of CC1 and CC2, i.e., uplink subframes appear in multiple carriers simultaneously, Ack/Nack is transmitted in PUCCH of PCC or in PUSCH of SCC with minimum SCellIndex.

FIG. 4 illustrates the feedback of Ack/Nacks according to the second solution of Feature A of the disclosure.

Subframes 7 and 8 of CC1 may feed back Ack/Nack of other CC.

For subframes 2 and 3 of CC1, i.e., uplink subframes appear in multiple carriers simultaneously, Ack/Nack is transmitted in PUCCH of PCC or in PUSCH of SCC with minimum SCellIndex.

In the first and second solutions of Feature A, in a case that the corresponding subframe transmits only one PUCCH, SCC is permitted to carry PUCCH. In FIG. 4, in a case that CC2 is PCC and CC1 is SCC, subframes 7 and 8 of CC1 are permitted to transmit PUCCH.

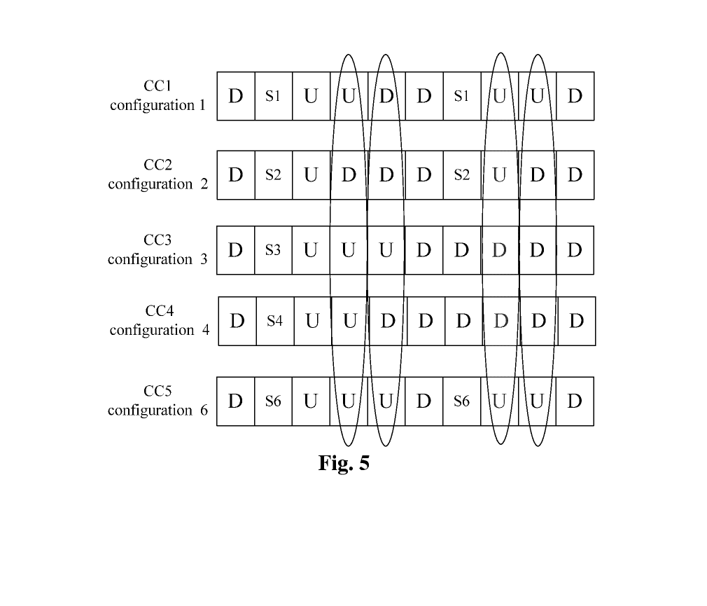

FIG. 5 illustrates the feedback of Ack/Nacks according to Feature B. There are five carriers with different uplink-downlink configurations are aggregated. Assumed that CC4 is PCC (SCellIndex is 0), and SCellIndexs of CC1, CC2, CC3 and CC5 are 1, 2, 3 and 4 respectively. SCC is permitted to transmit PUCCH; for uplink subframes appeared in multiple SCCs in the ellipse, only SCC with minimum SCellIndex is permitted to transmit PUCCH for a certain subframe. For example, for subframe 3, only CC1 is permitted to transmit PUCCH; for subframe 4, only CC3 is permitted to transmit PUCCH; for subframes 7 and 8, only CC1 is permitted to transmit PUCCH.

FIGS. 2(a) and 2(b) may be considered as an embodiment of the second solution of Feature C of the disclosure, i.e., only carriers with the same duration for switching from downlink to uplink are permitted to be aggregated, and carriers with arbitrary uplink-downlink configurations are not permitted to be aggregated.

The above descriptions are only preferable embodiments of the disclosure, but not the limitation thereof. Any modification, equivalent replacement and improvement made within the spirit and principle of the disclosure should fall into the protection scope of the disclosure.

1. A feedback method for different uplink-downlink configurations for LTE-A TDD, comprising:
configuring different bands in time division duplex (TDD) with different uplink-downlink configurations, wherein for asymmetric uplink and downlink subframes in a carrier aggregation scenario, an uplink subframe of each component carrier is used to feed back a feedback message Ack/Nack of a physical downlink shared channel (PDSCH) of a downlink subframe of the component carrier itself, but is not used to feed back the Ack/Nack message of other carrier.

2. The method according to claim 1, wherein the method further comprises: when uplink subframes appear in all the component carriers simultaneously, determining whether a physical uplink control channel (PUCCH) is carried on a primary component carrier (PCC), and if it is, feeding back the Ack/Nack message by the physical uplink control channel (PUCCH) carried on the primary component carrier (PCC).

3. The method according to claim 2, wherein the method further comprises: if the physical uplink control channel (PUCCH) is not carried on the primary component carrier (PCC), selecting a physical uplink shared channel (PUSCH) of a secondary component carrier (SCC) with a minimum secondary cell index value to feed back the feedback message Ack/Nack.

4. The method according to claim 1, wherein for the asymmetric uplink and downlink subframes in the carrier aggregation scenario, a secondary component carrier (SCC) is permitted to carry a physical uplink control channel (PUCCH) if only one physical uplink control channel (PUCCH) is transmitted in a corresponding subframe; if for a subframe there are multiple uplink subframes and one or more downlink subframes which are asymmetric, the secondary component carrier (SCC) with a minimum secondary cell index value is selected to transmit the physical uplink control channel (PUCCH).

5. The method according to claim 1, wherein all component carriers participated in the carrier aggregation have a same duration for switching from downlink to uplink.

6. A feedback method for different uplink-downlink configurations for LTE-A TDD, comprising:
configuring different bands in time division duplex (TDD) with different uplink-downlink configurations, wherein for asymmetric uplink and downlink subframes in a carrier aggregation scenario, a Ack/Nack message of a downlink subframe of each component carrier is fed back by an uplink subframe which belongs to a secondary cell (SCC) with a minimum secondary cell index value and which is the first uplink subframe at least four subframes later, and Ack/Nack messages of multiple carriers are permitted to be transmitted on other carrier.

7. The method according to claim 6, wherein the method further comprises: when uplink subframes appear in all the component carriers simultaneously, determining whether a physical uplink control channel (PUCCH) is carried on a primary component carrier (PCC), and if it is, feeding back the feedback message Ack/Nack by the physical uplink control channel (PUCCH) carried on the primary component carrier (PCC).

8. The method according to claim 7, wherein the method further comprises: if the physical uplink control channel (PUCCH) is not carried on the primary component carrier (PCC), selecting a physical uplink shared channel (PUSCH) of a secondary component carrier (SCC) with a minimum secondary cell index value to feed back the Ack/Nack message.

9. The method according to claim 6, wherein for the asymmetric uplink and downlink subframes in the carrier aggregation scenario, a secondary component carrier (SCC) is permitted to carry a physical uplink control channel (PUCCH) if only one physical uplink control channel (PUCCH) is transmitted in a corresponding subframe; if for a subframe there are multiple uplink subframes and one or more downlink subframes which are asymmetric, the secondary component carrier (SCC) with a minimum secondary cell index value is selected to transmit the physical uplink control channel (PUCCH).

10. The method according to claim 6, wherein all component carriers participated in the carrier aggregation have a same duration for switching from downlink to uplink.

11. The method according to claim 2, wherein all component carriers participated in the carrier aggregation have a same duration for switching from downlink to uplink.

12. The method according to claim 3, wherein all component carriers participated in the carrier aggregation have a same duration for switching from downlink to uplink.

13. The method according to claim 4, wherein all component carriers participated in the carrier aggregation have a same duration for switching from downlink to uplink.

14. The method according to claim 7, wherein all component carriers participated in the carrier aggregation have a same duration for switching from downlink to uplink.

15. The method according to claim 8, wherein all component carriers participated in the carrier aggregation have a same duration for switching from downlink to uplink.

16. The method according to claim 9, wherein all component carriers participated in the carrier aggregation have a same duration for switching from downlink to uplink.
